(19) United States
(12) Patent Application Publication
(10) Pub. No.: US 2023/0003077 A1
(43) Pub. Date: Jan. 5, 2023

(54) Scratch Guard Assembly

(71) Applicant: Jeff Robbins, Pascoe, WA (US)

(72) Inventor: Jeff Robbins, Pascoe, WA (US)

(21) Appl. No.: 17/363,143

(22) Filed: Jun. 30, 2021

(51) Int. Cl. E06B 1/34

(52) U.S. Cl. CPC E06B 1/34

(57) ABSTRACT

A scratch guard assembly for inhibiting an animal from damaging weather stripping on a door includes a member that is positioned against a door jamb having the member being positioned adjacent to weather stripping on the door jamb. The member is comprised of a scratch resistant material to inhibit an animal from being able to scratch the weather stripping beneath the member. The member is comprised of an ultraviolet radiation resistant material to resist being degraded by sunlight. The member is comprised of a thermally expansive material to withstand extreme temperatures. A plurality of fasteners is each extendable through the member to engage the door jamb to retain the member on the door jamb.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to guard devices and more particularly pertains to a new guard device for inhibiting an animal from damaging weather stripping on a door. The device includes a resilient member that is mounted to a door jamb is positioned adjacent to weather stripping on the door jamb. In this way an animal does not damage the weather stripping when the animal scratches the door jamb or door to be let in.

### (2) Description of Related Art Including Information Disclosed Under 37 CFR 1.97 and 1.98

The prior art relates to guard devices including a ridged scratch plate that is mountable to a door to produce an audible sound when an animal scratches the ridged scratch plate to be let in. The prior art discloses a panel that can be suspended from a door knob to protect a finish of a door from being scratched by an animal. The prior art discloses an angled member that is positionable around a corner of a pair of walls for protecting the corner from being scratched by an animal. The prior art discloses a member that is wrapped with rope for facilitating a feline to scratch the rope.

### BRIEF SUMMARY OF THE INVENTION

An embodiment of the disclosure meets the needs presented above by generally comprising a member that is positioned against a door jamb having the member being positioned adjacent to weather stripping on the door jamb. The member is comprised of a scratch resistant material to inhibit an animal from being able to scratch the weather stripping beneath the member. The member is comprised of an ultraviolet radiation resistant material to resist being degraded by sunlight. The member is comprised of a thermally expansive material to withstand extreme temperatures. A plurality of fasteners is each extendable through the member to engage the door jamb to retain the member on the door jamb.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of a scratch guard assembly according to an embodiment of the disclosure.

FIG. 2 is a front view of an embodiment of the disclosure.

FIG. 3 is a back view of an embodiment of the disclosure.

FIG. 4 is a back perspective view of an alternative embodiment of the disclosure.

FIG. 5 is a back view of an alternative embodiment of the disclosure.

FIG. 6 is a perspective in-use view of an embodiment of the disclosure showing a member being mounted to a door jamb.

FIG. 7 is a perspective in-use view of an embodiment of the disclosure.

### DETAILED DESCRIPTION OF THE INVENTION

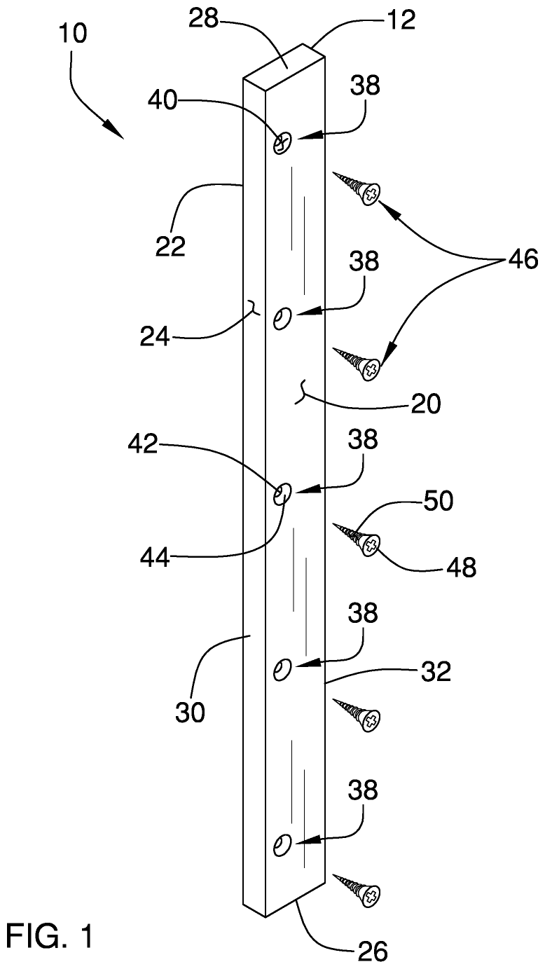

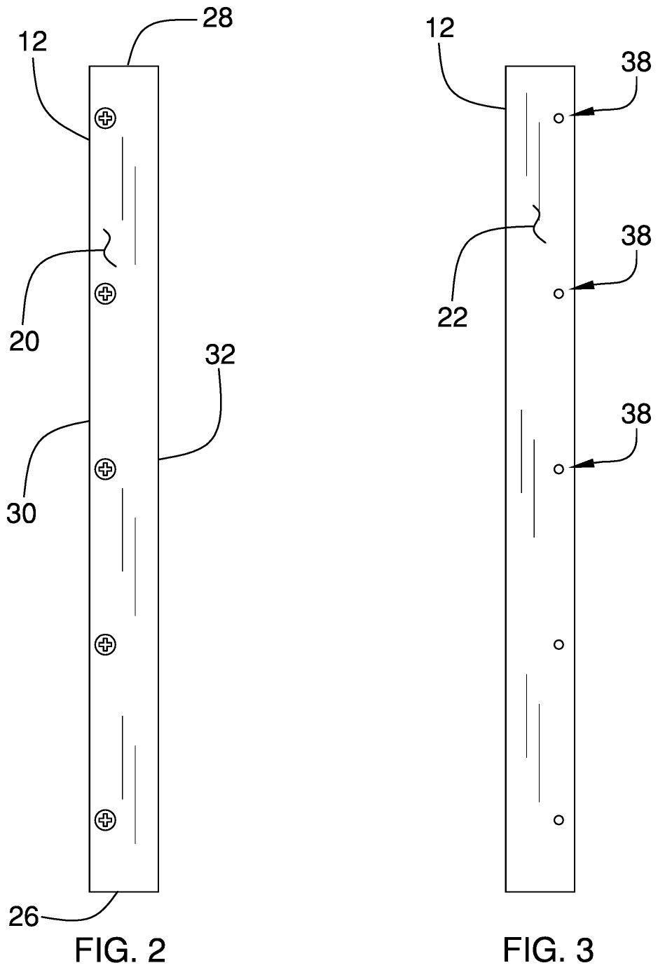

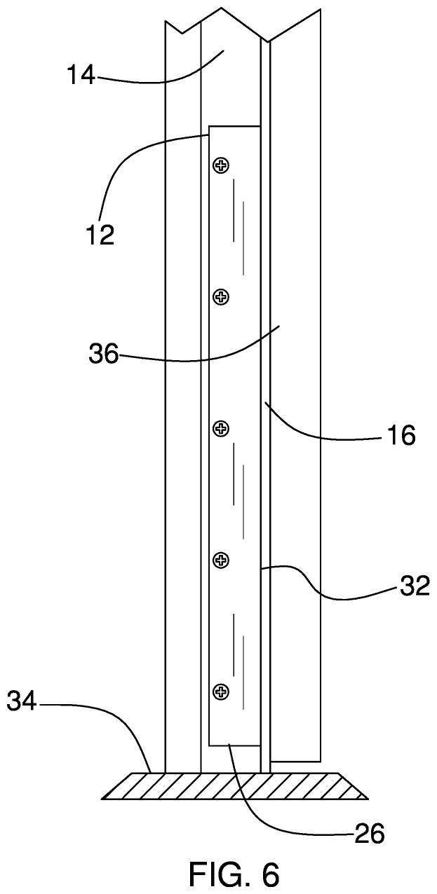

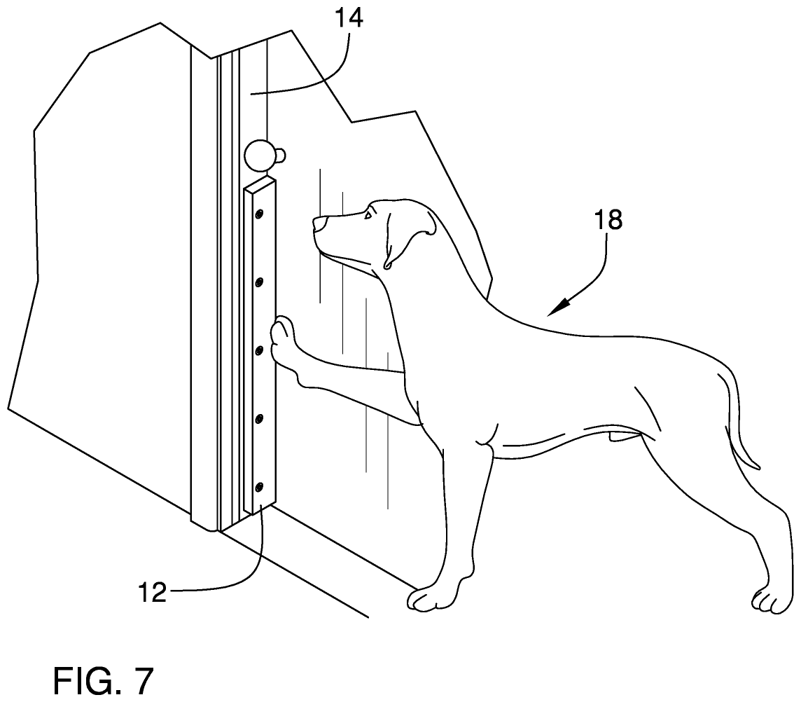

With reference now to the drawings, and in particular to FIGS. 1 through 7 thereof, a new guard device embodying the principles and concepts of an embodiment of the disclosure and generally designated by the reference numeral 10 will be described.

As best illustrated in FIGS. 1 through 7, the scratch guard assembly 10 generally comprises a member 12 that is elongated such that the member 12 can be positioned against a door jamb 14 having the member 12 being positioned adjacent to weather stripping 16 on the door jamb 14. The member 12 is comprised of a scratch resistant material to inhibit an animal 18 from being able to scratch the weather stripping 16 beneath the member 12. Additionally, the member 12 is comprised of an ultraviolet radiation resistant material to resist being degraded by sunlight. The member 12 is comprised of a thermally expansive material to withstand extreme temperatures.

The member 12 has a first surface 20, a second surface 22 and a perimeter surface 24 extending between the first surface 20 and the second surface 22, and the perimeter surface 24 has a lower side 26, an upper side 28, a first lateral side 30 and a second lateral side 32. The member 12 is elongated between the upper side 28 and the lower side 26 to a length of at least 24.0 inches. The first surface 20 is positionable against the door jamb 14 having the lower side 26 being spaced from a lower portion 34 of the door jamb 14 to inhibit moisture from wicking upwardly along the member 12. Furthermore, the first lateral side 30 is spaced from a door 36 that is hingedly disposed in the door jamb 14 to facilitate the door 36 to be closed unimpeded against the weather stripping 16. The door jamb 14 may be a door jamb for an exterior door in a building and the door 36 in the door jamb 14 may be an exterior door.

The member 12 has a plurality of apertures 38 each extending through the first surface 20 and the second surface 22. The apertures 38 are spaced apart from each other and are distributed between the upper side 28 and the lower side 26, and each of the apertures 38 is positioned closer to the second lateral side 32 than the first lateral side 30. Each of the apertures 38 has a bounding surface 40 and the bounding surface 40 of each of the apertures 38 has a first portion 42 extending from the first surface 20 toward the second surface 22. The bounding surface 40 of each of the apertures 38 has a second portion 44 angling outwardly between the first portion 42 and the second surface 22 to define a countersink in each of the apertures 38.

A plurality of fasteners 46 is each extendable through the member 12 to engage the door jamb 14 to retain the member 12 on the door jamb 14. Each of the fasteners 46 has a head 48 and the head 48 has a bottom surface 50 which is sloped. Each of the fasteners 46 is extendable through a respective one of the apertures 38 having the bottom surface 50 of the head 48 abutting the second portion 44 of the bounding surface 40 of the respective aperture. In this way the head 48 is recessed with respect to the second surface 22 of the member 12. Additionally, each of the fasteners 46 may comprise a screw, a nail or other type of penetrating fastener.

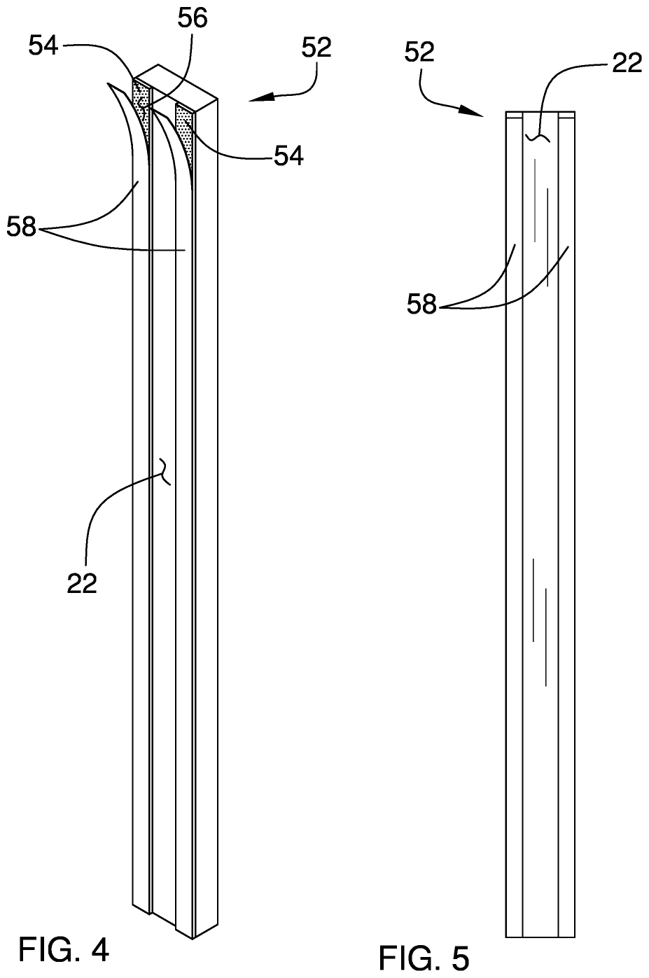

In an alternative embodiment 52 as is most clearly shown in FIGS. 4 and 5, a pair of mating members 54 is provided and each of the mating members 54 is disposed on the first surface 20 of the member 12. Each of the mating members 54 extends between the upper side 28 and the lower side 26 of the perimeter surface 24 of the member 12. Each of the mating members 54 has an exposed surface 56 with respect to the first surface 20 of the member 12. The exposed surface 56 of each of the mating members 54 is comprised of an adhesive material such that the exposed surface 56 of each of the mating members 54 can adhere to the door jamb 14. A pair of protective sheets 58 is each removably positioned on the exposed surface 56 of a respective one of the mating members 54 for inhibiting the exposed surface 56 from being adhered to a surface.

In use, the member 12 is mounted to the door jamb 14 such that the weather stripping 16 is positioned between the member 12 and the door 36. In this way an animal 18, such as a domesticated dog, is not able to damage the weather stripping 16 when the animal 18 scratches on the member 12 to notify a pet owner that the animal 18 wishes to enter the door 36. Thus, the door 36 can continue to function normally over extended periods of time without being damaged by the animal 18 scratching against the member 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A scratch guard assembly for protecting a door jamb and weather stripping from being scratched by an animal, said assembly comprising:
a member being elongated wherein said member is configured to be positioned against a door jamb having said member being positioned adjacent to weather stripping on the door jamb, said member being comprised of a scratch resistant material wherein said member is configured to inhibit an animal from being able to scratch the weather stripping beneath said member, said member being comprised of a ultraviolet radiation resistant material wherein said member is configured to resist being degraded by sunlight, said member being comprised of a thermally expansive material wherein said member is configured to withstand extreme temperatures; and
a plurality of fasteners, each of said fasteners being extendable through said member to engage the door jamb wherein each of said fasteners is configured to retain said member on the door jamb.

2. The assembly according to claim 1, wherein said member has a first surface, a second surface and a perimeter surface extending between said first surface and said second surface, said perimeter surface having a lower side, an upper side, a first lateral side and a second lateral side, said member being elongated between said upper side and said lower side, said first surface being positionable against the door jamb having said lower side being spaced from a lower portion of the door jamb wherein said member is configured to inhibit moisture from wicking upwardly along said member, said first lateral side being spaced from a door being hingedly disposed in the door jamb wherein said first lateral side is configured to facilitate the door to be closed unimpeded against the weather stripping.

3. The assembly according to claim 1, wherein:
said member has a first surface, a second surface and a perimeter surface extending between said first surface and said second surface, said perimeter surface having an upper side, a lower side, a first lateral side and a second lateral side; and
said member has a plurality of apertures each extending through said first surface and said second surface, said apertures being spaced apart from each other and being distributed between said upper side and said lower side, each of said apertures being positioned closer to said second lateral side than said first lateral side, each of said apertures having a bounding surface, said bounding surface of each of said apertures having a first portion extending from said first surface toward said second surface, said bounding surface of each of said apertures having a second portion angling outwardly between said first portion and said second surface to define a countersink in each of said apertures.

4. The assembly according to claim 3, wherein each of said fasteners has a head, said head having a bottom surface being sloped, each of said fasteners being extendable through a respective one of said apertures having said bottom surface of said head abutting said second portion of said bounding surface of said respective aperture.

5. A scratch guard assembly for protecting a door jamb and weather stripping from being scratched by an animal, said assembly comprising:
a member being elongated wherein said member is configured to be positioned against a door jamb having said member being positioned adjacent to weather stripping on the door jamb, said member being comprised of a scratch resistant material wherein said member is configured to inhibit an animal from being able to scratch the weather stripping beneath said member, said member being comprised of a ultraviolet radiation resistant material wherein said member is configured to resist being degraded by sunlight, said member being comprised of a thermally expansive material wherein said member is configured to withstand extreme temperatures, said member having a first surface, a second surface and a perimeter surface extending between said first surface and said second surface, said perimeter surface having a lower side, an upper side, a first lateral side and a second lateral side, said member being elongated between said upper side and said lower side, said first surface being positionable against the door jamb having said lower side being spaced from a lower portion of the door jamb wherein said member is configured to inhibit moisture from wicking upwardly along said member, said first lateral side being spaced from a door being hingedly disposed in the door jamb wherein said first lateral side is configured to facilitate the door to be closed unimpeded against the weather stripping, said member having a plurality of apertures each extending through said first surface and said second surface, said apertures being spaced apart from each other and being distributed between said upper side and said lower side, each of said apertures being positioned closer to said second lateral side than said first lateral side, each of said apertures having a bounding surface, said bounding surface of each of said apertures having a first portion extending from said first surface toward said second surface, said bounding surface of each of said apertures having a second portion angling outwardly between said first portion and said second surface to define a countersink in each of said apertures; and
a plurality of fasteners, each of said fasteners being extendable through said member to engage the door jamb wherein each of said fasteners is configured to retain said member on the door jamb, each of said fasteners having a head, said head having a bottom surface being sloped, each of said fasteners being extendable through a respective one of said apertures having said bottom surface of said head abutting said second portion of said bounding surface of said respective aperture.

6. A scratch guard assembly for protecting a door jamb and weather stripping from being scratched by an animal, said assembly comprising:
a member being elongated wherein said member is configured to be positioned against a door jamb having said member being positioned adjacent to weather stripping on the door jamb, said member being comprised of a scratch resistant material wherein said member is configured to inhibit an animal from being able to scratch the weather stripping beneath said member, said member being comprised of a ultraviolet radiation resistant material wherein said member is configured to resist being degraded by sunlight, said member being comprised of a thermally expansive material wherein said member is configured to withstand extreme temperatures, said member having a first surface, a second surface and a perimeter surface extending between said first surface and said second surface, said perimeter surface having a lower side, an upper side, a first lateral side and a second lateral side, said member being elongated between said upper side and said lower side, said first surface being positionable against the door jamb having said lower side being spaced from a lower portion of the door jamb wherein said member is configured to inhibit moisture from wicking upwardly along said member, said first lateral side being spaced from a door being hingedly disposed in the door jamb wherein said first lateral side is configured to facilitate the door to be closed unimpeded, said member having a plurality of apertures each extending through said first surface and said second surface, said apertures being spaced apart from each other and being distributed between said upper side and said lower side, each of said apertures being positioned closer to said second lateral side than said first lateral side, each of said apertures having a bounding surface, said bounding surface of each of said apertures having a first portion extending from said first surface toward said second surface, said bounding surface of each of said apertures having a second portion angling outwardly between said first portion and said second surface to define a countersink in each of said apertures; and
a plurality of fasteners, each of said fasteners being extendable through said member to engage the door jamb wherein each of said fasteners is configured to retain said member on the door jamb, each of said fasteners having a head, said head having a bottom surface being sloped, each of said fasteners being extendable through a respective one of said apertures having said bottom surface of said head abutting said second portion of said bounding surface of said respective aperture.

7. The assembly according to claim 6, further comprising a pair of mating members, each of said mating members being disposed on said first surface of said member, each of said mating members extending between said upper side and said lower side of said perimeter surface of said member, each of said mating members having an exposed surface with respect to said first surface of said member, said exposed surface of each of said mating members being comprised of an adhesive material wherein said exposed surface of each of said mating members is configured to adhere to the door jamb.

8. The assembly according to claim 7, further comprising a pair of protective sheets, each of said protective sheets being removably positioned on said exposed surface of a respective one of said mating members for inhibiting said exposed surface from being adhered to a surface.
